(19) United States
(12) Patent Application Publication
(10) Pub. No.: US 2024/0411635 A1
(43) Pub. Date: Dec. 12, 2024

(54) METHODS, SYSTEMS, AND STORAGE MEDIA FOR INTELLIGENT DIAGNOSIS OF DEVICE FAILURES BASED ON INDUSTRIAL INTERNET OF THINGS (IIOT)

(71) Applicant: CHENGDU QINCHUAN IOT TECHNOLOGY CO., LTD., Chengdu, Sichuan (CN)

(72) Inventor: Hanshu SHAO, Chengdu (CN)

(73) Assignee: CHENGDU QINCHUAN IOT TECHNOLOGY CO., LTD., Chengdu, Sichuan (CN)

(21) Appl. No.: 18/805,699

(22) Filed: Aug. 15, 2024

(30) Foreign Application Priority Data
Jul. 29, 2024 (CN) 202411017663.4

(51) Int. Cl. G06F 11/07; G06F 11/30

(52) U.S. Cl. CPC G06F 11/079; G06F 11/3075; G06F 11/3089

(57) ABSTRACT

Provided are a method, a system, and a storage medium for intelligent diagnosis of a device failure based on an IIoT. The method includes: obtaining device-related data of an abnormal device from a total sensor database; predicting failure warning information of the abnormal device and a confidence level corresponding to the failure warning information based on the device-related data; determining a failure processing parameter based on the failure warning information and the confidence level, and generating a failure processing instruction; and sending the failure processing instruction via the device sensor network platform to a maintenance personnel terminal of the device perception and control platform or to a failure shooting device, and controlling the failure shooting device to perform failure shooting.

### CROSS-REFERENCE TO RELATED APPLICATIONS

This application claims priority to Chinese Patent Application No. 202411017663.4, filed on Jul. 29, 2024, the entire content of which is hereby incorporated by reference.

### TECHNICAL FIELD

The present disclosure relates to the field of Industrial Internet of Things (IIoT), and in particular, to a method, a system, and a storage medium for intelligent diagnosis of a device failure based on an Industrial Internet of Things (IIoT).

### BACKGROUND

The Industrial Internet of Things (IIoT) mainly refers to an application of the Internet of Things (IoT) technology in the industrial field, which realizes the collection, transmission, analysis, and application of data by interconnecting a variety of intelligent devices, systems, and networks, thus improving the efficiency, quality, and safety of industrial production. However, as types of industrial devices become more and more complex, and as more and more parameters are captured by the industrial devices, device failures are frequent and maintenance costs are high. Traditional methods for diagnosis of device failures rely on manual inspection and expert experience, which have lower levels of intelligence and reliability, and are unable to meet the needs of efficient management of a large-scale device group. In addition, the traditional methods are not well-suited for an automatic assembly device on a mixed production line. Due to varying types of parts of the automatic assembly device and sources of the parts, it is challenging to identify the parts causing device failures and the impact of failures on different products.

Therefore, a method, a system, and a storage medium for intelligent diagnosis of a device failure based on an Industrial Internet of Things (IIoT) are provided, which are capable of diagnosing the device failure more accurately, improving the stability and productivity of a production line, accurately determining the source causing the device failure and handling the failure in time, reducing the impact of device failure on production, and improving the reliability and service life of the device.

### SUMMARY

One or more embodiments of the present disclosure provide a method for intelligent diagnosis of a device failure based on an Industrial Internet of Things (IIoT). The method may be executed by a device management platform of a system for intelligent diagnosis of the device failure based on the IIoT. The method may include: obtaining device-related data of an abnormal device from a total sensor database, wherein the device-related data includes at least one of real-time log data, historical log data, historical failure data, and peripheral associated data, and the device-related data is obtained from a device perception and control platform through a device sensor network platform; predicting failure warning information of the abnormal device and a confidence level corresponding to the failure warning information based on the device-related data; determining a failure processing parameter based on the failure warning information and the confidence level, and generating a failure processing instruction; and sending the failure processing instruction via the device sensor network platform to a maintenance personnel terminal of the device perception and control platform or to a failure shooting device, and controlling the failure shooting device to perform failure shooting.

One or more embodiments of the present disclosure provide a system for intelligent diagnosis of a device failure based on an Industrial Internet of Things (IIoT). The system may include a user platform, a service platform, a device management platform, a device sensor network platform, and a device perception and control platform connected in sequence. The device management platform includes a management data center and a plurality of device management sub-platforms interacting with the management data center for information exchange, respectively. The device sensor network platform includes a total sensor database, a plurality of sensor sub-databases, and a plurality of sensor network sub-platforms. The plurality of sensor sub-databases interact with the total sensor database for information exchange, respectively, and the plurality of sensor sub-databases have a one-to-one correspondence with the plurality of sensor network sub-platforms and interact with the plurality of sensor network sub-platforms for information exchange, respectively. The device sensor network platform interacts with the device management platform for information exchange through the total sensor database. The device perception and control platform includes a plurality of device perception and control sub-platforms, the device sensor network platform interacts with the plurality of device perception and control sub-platforms of the device perception and control platform for information exchange, respectively, through the plurality of sensor sub-databases. The device management platform is configured to: obtain device-related data of an abnormal device from the total sensor database, wherein the device-related data includes at least one of real-time log data, historical log data, historical failure data, and peripheral associated data, and the device-related data is obtained from the device perception and control platform through the device sensor network platform; predict failure warning information of the abnormal device and a confidence level corresponding to the failure warning information based on the device-related data; determine a failure processing parameter based on the failure warning information and the confidence level, and generating a failure processing instruction; send the failure processing instruction via the device sensor network platform to a maintenance personnel terminal of the device perception and control platform or to a failure shooting device, and control the failure shooting device to perform failure shooting.

One or more embodiments of the present disclosure provide a computer-readable storage medium. The storage medium stores one or more sets of computer instructions, and when a computer reads the one or more sets of computer instructions in the storage medium, the computer implements the method for intelligent diagnosis of a device failure based on IIoT described above.

### BRIEF DESCRIPTION OF THE DRAWINGS

The present disclosure will be further illustrated by way of exemplary embodiments, which will be described in detail through the accompanying drawings. These embodiments are not limiting, and in these embodiments the same numbering indicates the same structure, wherein:

FIG. 1 is a schematic diagram of an exemplary structure of platforms of a system for intelligent diagnosis of a device failure based on an Industrial Internet of Things (IIoT) according to some embodiments of the present disclosure;

FIG. 2 is a flowchart of an exemplary process of a method for intelligent diagnosis of a device failure based on an Industrial Internet of Things (IIoT) according to some embodiments of the present disclosure;

FIG. 3 is a flowchart of an exemplary process for predicting failure warning information and a confidence level according to some embodiments of the present disclosure;

FIG. 4 is a flowchart of an exemplary process for determining a device failure type and a failure processing parameter according to some embodiments of the present disclosure;

FIG. 5 is an exemplary partial schematic diagram of a failure knowledge map according to some embodiments of the present disclosure; and

FIG. 6 is an exemplary schematic diagram of a determination model according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

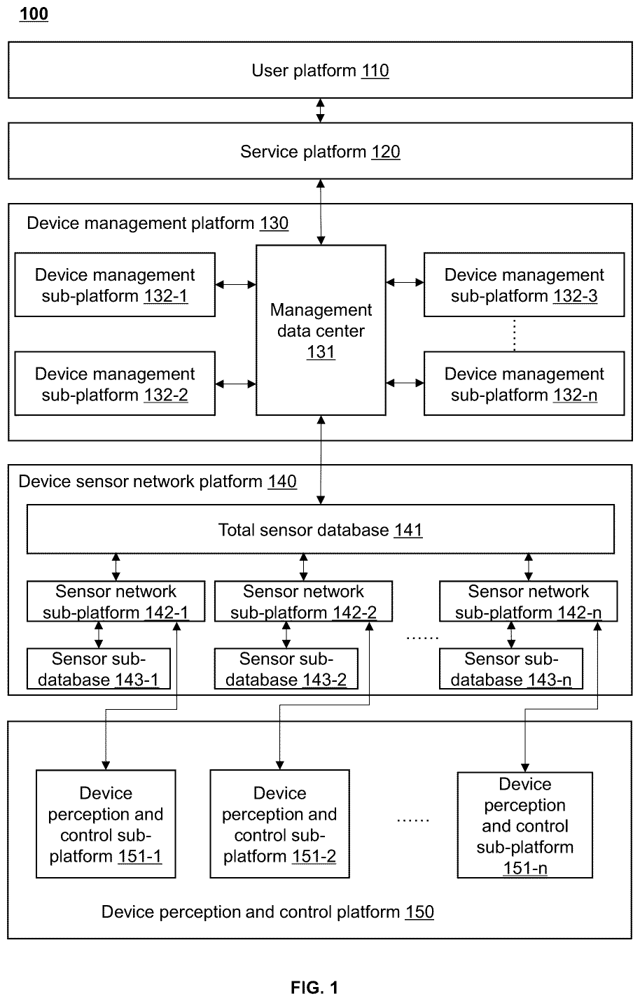

FIG. 1 is a schematic diagram of an exemplary structure of platforms of a system for intelligent diagnosis of a device failure based on an Industrial Internet of Things (IIoT) according to some embodiments of the present disclosure. The system for intelligent diagnosis of the device failure based on the IIoT involved in the embodiments of the present disclosure will be described in detail below. It should be noted that the following embodiments are used only for explaining the present disclosure and do not constitute a limitation of the present disclosure.

In some embodiments, as shown in FIG. 1, a system 100 for intelligent diagnosis of a device failure based on an IIoT (hereinafter the system 100) may include a user platform 110, a service platform 120, a device management platform 130, a device sensor network platform 140, and a device perception and control platform 150 connected in sequence.

The user platform 110 is a platform for interacting with a user. In some embodiments, the user platform may be configured as one or more terminal devices. The one or more terminal devices may include a mobile device, a tablet computer, a laptop computer, etc. The user may be a manager or an inspector, etc. In some embodiments, the user platform 110 may be configured to receive device-related data, a failure processing parameter, etc., and to generate a user instruction for decision-making management of manufacturing. The user instruction is an instruction issued by the user to control, monitor, or configure a device or the system 100. For example, the user instruction may include replacing a damaged part, reinstalling software, removing a foreign object from machinery, etc.

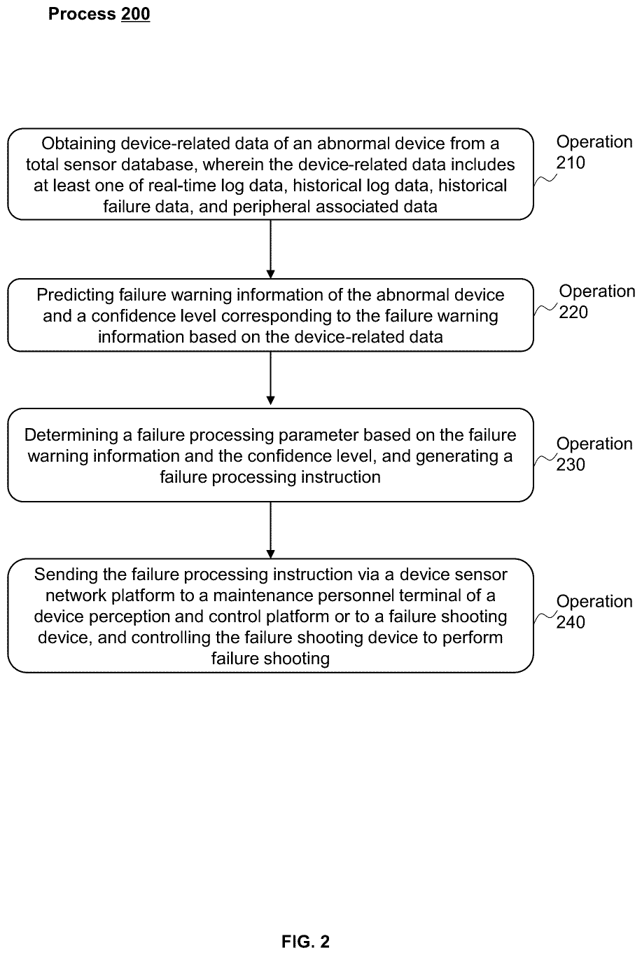

More descriptions of the device-related data and the failure processing parameter may be found in FIG. 2 and the related descriptions thereof

The service platform 120 is a platform for communicating the user's needs and control information. In some embodiments, the service platform 120 may be configured to obtain the device-related data from the device management platform 130 and send the device-related data and the failure processing parameter, etc., to the user platform 110. In some embodiments, the service platform 120 may be configured to acquire and process the user instruction sent by the user platform 110 and transmit the user instruction to the device management platform.

The device management platform 130 may be a platform that harmonizes and coordinates functional platforms and aggregates all information of the IIoT to provide sensor management and control management functions for the operation of the IIoT. In some embodiments, the device management platform 130 may include a management data center 131 and a plurality of device management sub-platforms that interact with the management data center 131, respectively. For example, as shown in FIG. 1, the device management platform 130 may include a device management sub-platform 132-1, a device management sub-platform 132-2, a device management sub-platform 132-3, . . . , and a device management sub-platform 132-n. The device management platform 130 may interact with the service platform 120 and the device sensor network platform 140 respectively through the management data center 131.

The management data center 131 is a platform for storing and managing all data of the system 100. In some embodiments, the management data center 131 may be configured as a storage device for storing data related to failure processing, such as the device-related data. The device management platform is a platform for processing the device-related data. The device management platform 130 may be configured to receive and process the device-related data of different devices from the management data center 131 based on different device management sub-platforms.

In some embodiments, the device management platform 130 may be configured to: obtain the device-related data of an abnormal device from the total sensor database, wherein the device-related data includes at least one of real-time log data, historical log data, historical failure data, and peripheral associated data, and the device-related data is obtained from the device perception and control platform through the device sensor network platform; predict failure warning information of the abnormal device and a confidence level corresponding to the failure warning information based on the device-related data; determine a failure processing parameter based on the failure warning information and the confidence level, and generating a failure processing instruction; send the failure processing instruction via the device sensor network platform to a maintenance personnel terminal of the device perception and control platform or to a failure shooting device, and control the failure shooting device to perform failure shooting. More descriptions of the operations performed by the device management platform 130 may be found in FIGS. 2-5 and the related descriptions thereof

The device sensor network platform 140 is a functional platform for managing sensor communications. In some embodiments, the device sensor network platform 140 may be configured as a communication network or a gateway etc. In some embodiments, the device sensor network platform 140 utilizes a distributed architecture that combines central computing and edge computing. In some embodiments, the device sensor network platform 140 may include a total sensor database 141, a plurality of sensor sub-databases, and a plurality of sensor network sub-platforms.

The sensor sub-databases are databases that manage communication of information related to different devices. The total sensor database is a database that manages communication of information related to all devices. The sensor network sub-platform are platforms that manage sensor communications of different devices. In some embodiments, the plurality of sensor sub-databases interact with the total sensor database 141 for information exchange, respectively, and the plurality of sensor sub-databases have a one-to-one correspondence with the plurality of sensor network sub-platforms and interact with the plurality of sensor network sub-platforms for information exchange, respectively. The device sensor network platform 140 interacts with the device management platform 130 for information exchange via the total sensor database 141.

In some embodiments, as shown in FIG. 1, the device sensor network platform 140 includes a sensor sub-database 142-1, a sensor sub-database 142-2, a sensor sub-database 142-3, . . . , a sensor sub-database 142-n. The device sensor network platform 140 includes a sensor network sub-platform 143-1, a sensor network sub-platform 143-2, a sensor network sub-platform 143-3, . . . , a sensor network sub-platform 143-n. The sensor network sub-platform 143-n interacts with the sensor sub-database 142-n. In some embodiments, the device perception and control platform 150 includes a plurality of device perception and control sub-platforms, the device sensor network platform 140 may interact with the plurality of device perception and control sub-platforms of the device perception and control platform 150 for information exchange, respectively, through the plurality of sensor sub-databases.

In some embodiments, the sensor sub-database may receive the device-related data collected and uploaded by the corresponding device perception and control sub-platform, and perform edge computing in conjunction with the corresponding sensor network sub-platform. In some embodiments, the sensor network sub-platform includes an edge computing module. The edge computing module may obtain the device-related data from the sensor sub-database, perform first pre-processing, and store the first pre-processed device-related data in the sensor sub-database. The sensor sub-database may send the first pre-processed device-related data to the total sensor database 141. The first pre-processing includes data parsing, checksumming, classification labeling, compression, packaging, etc.

In some embodiments, the total sensor database 141 may obtain the first pre-processed device-related data from the sensor sub-database and perform data source tagging to form tagged device-related data, and send the tagged device-related data to the management data center 131 of the device management platform 130. The tagging includes tagging of the abnormal device.

In some embodiments, the total sensor database 141 may tag a device whose corresponding first pre-processed device-related data satisfy a preset abnormal condition as the abnormal device. The preset abnormal condition may be set manually based on experience. For example, the preset abnormal condition may be that a count of alarms of a processed device exceeding a preset count of alarms threshold is the abnormal device. As another example, the preset abnormal condition may be that a data abnormality of the real-time log data is greater than a preset abnormality threshold. The data abnormality is a degree of abnormality of the real-time log data, which may be expressed as a grade or score. Exemplarily, the data abnormality level may include a Level 1 data abnormality, a Level 2 data abnormality, and a Level 3 data abnormality. The data abnormality of the real-time log data is positively correlated with a count of abnormal parameters in the real-time log data. The total sensor database 141 may identify a parameter in the real-time log data that has a value greater than a preset value as the abnormal parameter. For example, if the value of a current is greater than the preset value, the current is identified as the abnormal parameter. The preset value may be preset empirically. More descriptions of the device-related data may be found in FIG. 2 and the related descriptions.

The device perception and control platform 150 may be a functional platform for perceiving the generation of information and controlling the execution of information for devices. In some embodiments, the device perception and control platform 150 may include a plurality of device perception and control sub-platforms. For example, as shown in FIG. 1, the device perception and control platform 150 may include a device perception and control sub-platform 151-1, a device perception and control sub-platform 151-2, a device perception and control sub-platform 151-3, . . . , a device perception and control sub-platform 151-n. In some embodiments, the device perception and control sub-platforms may be configured as a variety of devices, e.g., a current sensor, a voltage sensor, a power meter, a temperature sensor, a tachometer, an alarm, a communication device, etc. In some embodiments, the device perception and control sub-platforms may also be configured as other related devices on a production line, etc.

In some embodiments, the device sensor network platform 140 interacts with a plurality of device perception and control sub-platforms of the device perception and control platform 150 through the plurality of sensor sub-databases for information exchange respectively. For example, as shown in FIG. 1, the device perception and control sub-platform 151-n may interact with the sensor sub-database 142-n for information exchange. In some embodiments, different device perception and control sub-platforms may correspond to different devices according to a preset rule. The preset rule is a rule that categorize and classify devices into different device perception and control sub-platforms, e.g., devices in different production workshops corresponding to different device perception and control sub-platforms, or devices in different production lines corresponding to different device perception and control sub-platforms, or different types of devices corresponding to different device perception and control sub-platforms, etc. In some embodiments, the device perception and control sub-platform includes a data acquisition module, and the device perception and control sub-platform may acquire the device-related data of the corresponding device based on the data acquisition module and transmit the device-related data to the corresponding sensor sub-database.

In some embodiments of the present disclosure, through the collaborative work division of various platforms of the system 100 for intelligent diagnosis of the device failure based on the IIoT, information exchange between platforms can be achieved, forming an information feedback loop. Under the unified management of the device management platform 130, coordination and systematic operation are realized, leading to the informatization and intelligence of failure processing.

FIG. 2 is a flowchart of an exemplary process of a method for intelligent diagnosis of a device failure based on an Industrial Internet of Things (IIoT) according to some embodiments of the present disclosure. As shown in FIG. 2, process 200 may include operations 210-240 described below. Process 200 is a process of the method for intelligent diagnosis of the device failure based on the IIoT. In some embodiments, operations 210-240 may be performed based on the device management platform 130 of the system 100 for intelligent diagnosis of the device failure based on the IIoT.

In 210, obtaining device-related data of an abnormal device from a total sensor database.

The device-related data refers to all types of data associated with a device. The device-related data includes at least one of real-time log data, historical log data, historical failure data, and peripheral associated data. The device-related data may be obtained from the device perception and control platform 150 via the device sensor network platform 140. The device may be a device of a wide range of application scenarios, for example, an automatic assembled device on a mixed production line, etc. The mixed production line is a production line where a plurality of different types of products may be produced simultaneously.

The device-related data of the abnormal device is data related to the abnormal device. For more detailed descriptions of the determination of the abnormal device, please refer to FIG. 1.

The real-time log data is data that reflects a real-time operating status of the device. In some embodiments, the real-time log data includes one or more of real-time operation data, real-time statistic data, real-time alarm data, a device real-time location, real-time status data, etc.

The real-time operation data is indicator data that reflects operational performance of the device at a current moment. For example, the real-time operation data may include a current, a voltage, an operating power, a temperature, and a rotational speed of the device at the current moment of operation.

The real-time statistic data refers to results obtained from counting and analyzing the real-time operation data. In some embodiments, the real-time statistic data may include a device operating duration and a product output.

The real-time alarm data refers to alarm-related information generated by the device when an abnormal or failure occurs during a current operation. For example, the real-time alarm data may include whether the device is currently generating an alarm message and an alarm type of the alarm message. The alarm type may include a volume alarm, an over-temperature warning, a pressure warning, etc.

The device real-time location is location information of the device at the current moment.

Status data is information data that responds to an operating status of the device. For example, the status data may include that the device is operating well or the device is operating abnormally. The real-time status data is the status data of the device at the current moment.

The historical log data is data reflecting a historical operating status of the device. In some embodiments, the historical log data may record data such as an operation condition, an operation record, an exception message, etc., of the device, the system 100, or an application during a certain period in the past. In some embodiments, the historical log data includes one or more of historical operation data, historical statistic data, historical alarm data, a historical device location, and historical status data.

The historical failure data is data related to failures that occurred during a historical operation of the device. For example, the historical failure data includes a historical failure time and a historical failure type. In some embodiments, the failure type may be an aging deformation of the device, a software failure, a missing part, etc.

The peripheral associated data is data about other devices or environments associated with the abnormal device that may affect or have a correlation with an operation status of the abnormal device. In some embodiments, the peripheral associated data may be data of a device whose physical distance from a location of a current device is less than a preset distance threshold, or data of a correlated device assembled upstream and downstream of the current device. The preset distance threshold may be preset in advance.

In some embodiments, the device management platform 130 may obtain the device-related data based on the total sensor database 141 in the device sensor network platform 140. The device sensor network platform 140 may obtain the device-related data from the device perception and control platform 150, and store the device-related data to the total sensor database 141. The device perception and control platform 150 may obtain the device-related data from the device management sub-platforms corresponding to different devices. For example, the device perception and control platform 150 may obtain the voltage/current of the device in operation via a voltage/current sensor etc., or obtain real-time alarm data of the device in operation via an alarm, etc.

In 220, predicting failure warning information of the abnormal device and a confidence level corresponding to the failure warning information based on the device-related data.

The failure warning information is an alarm message for the abnormal device that may fail in the future. In some embodiments, the failure warning information may include at least one of information of whether the abnormal device may fail at a preset future time and a failure type. More descriptions of the failure type may be found in the preceding related description.

The confidence level is a level that measures the confidence of the failure warning information. In some embodiments, the confidence level may be set at a low level, a medium level, or a high level. In some embodiments, the confidence level may also be set to other levels, which is not limited here.

In some embodiments, the device management platform 130 may predict the failure warning information of the abnormal device and the confidence level corresponding to the failure warning information based on the device-related data in a variety of ways.

For example, the device management platform 130 may, in response to determining that an alarm message is generated based on the real-time alarm data in the real-time log data of the abnormal device, determine the real-time alarm data as the failure warning information, and set the confidence level to the high level.

As another example, the device management platform 130 may, in response to determining that an alarm message is not generated based on the real-time alarm data in the real-time log data of the abnormal device and that an alarm message was generated in the historical alarm data, determine the historical alarm data corresponding to a most recent alarm message as the failure warning information, and set the confidence level to the medium level.

As yet another example, the device management platform 130 may, in response to determining that the real-time alarm data in the real-time log data of the abnormal device does not generate an alarm message and that there is a failure record in the historical failure data, determine a failure message of a most recent failure record as the failure warning information, and set the confidence level to the low level. As still another example, the device management platform 130 may, in response to determining that an associated device in the peripheral associated data has a failure, determine failure information of the associated device as the failure warning information, and set the confidence level to the low level.

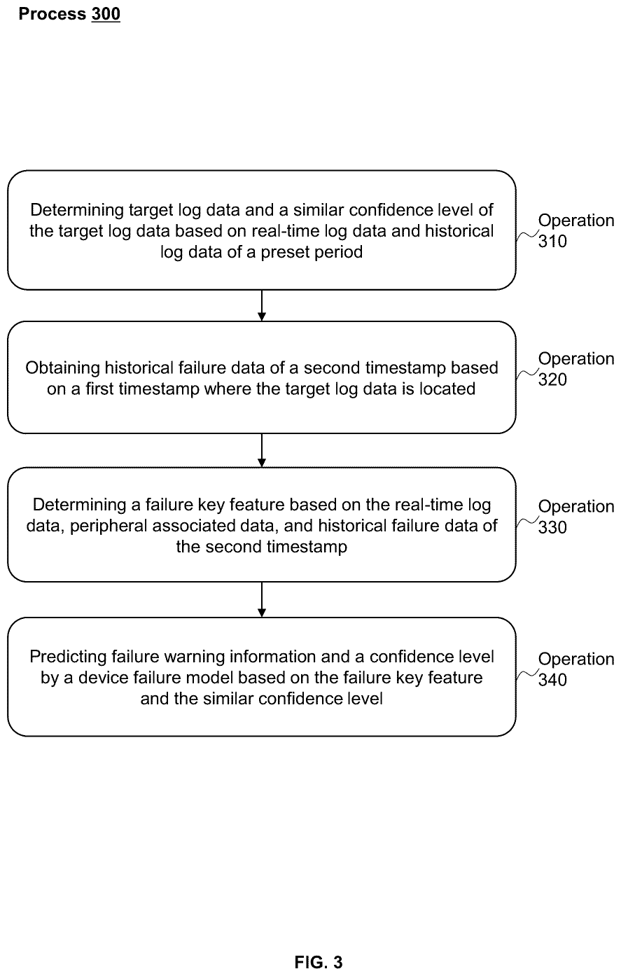

In some embodiments, the device management platform 130 may also determine target log data, a similar confidence level of the target log data, and a failure key feature, based on the real-time log data and the historical log data of a preset period; predict the failure warning information and the confidence level by a device failure model based on the failure key feature and the similar confidence level. More descriptions of this embodiment may be found in FIG. 3 and the related descriptions.

In 230, determining a failure processing parameter based on the failure warning information and the confidence level, and generating a failure processing instruction.

The failure processing parameter is a parameter associated with the handling of a device that may fail. In some embodiments, the failure processing parameter may include at least one of a maintenance parameter, a failure shooting parameter, etc. The maintenance parameter includes at least one of device maintenance steps, tools or parts required for maintenance, an estimated maintenance time, and corresponding maintenance personnel. The failure shooting parameter may include at least one of a count of failure shooting devices, locations of the failure shooting devices, etc. More descriptions of the failure shooting device may be found below.

In some embodiments, the device management platform 130 may look up a preset relationship table to determine the failure processing parameter based on the failure warning information and the confidence level. The preset relationship table includes a mapping relationship between the failure warning information, confidence levels, and failure processing parameters. In some embodiments, the device management platform 130 may determine a failure processing parameter that appears most frequently under each piece of failure warning information and the failure confidence level corresponding to the piece of failure warning information in the historical data as the corresponding failure processing parameter and include piece of failure warning information and the failure confidence level corresponding to the piece of failure warning information in the preset relationship table.

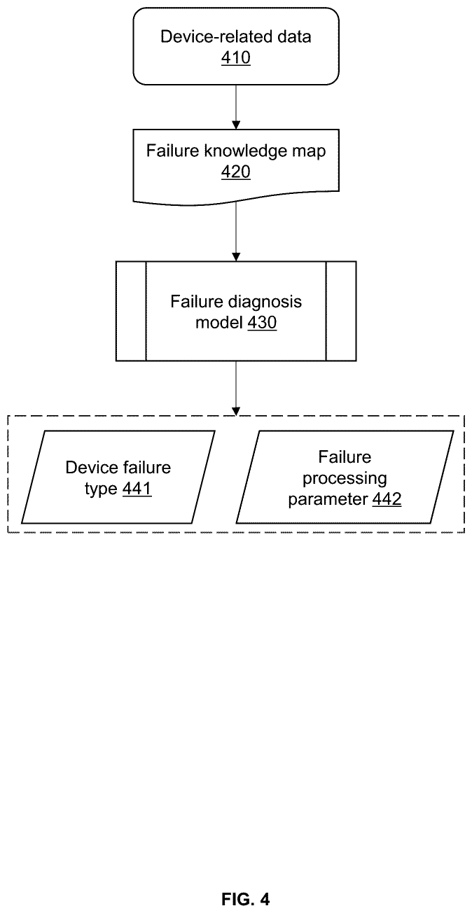

In some embodiments, in response to the confidence level meeting a preset condition, the device management platform 130 may construct a failure knowledge map, and determine the failure processing parameter based on the failure knowledge map by a failure diagnosis model. More descriptions of determination of the failure processing parameter may be found in the relevant description of FIG. 4.

The failure processing instruction is an operational command that deal with a device that may be malfunctioning.

In some embodiments, the device management platform 130 may generate the failure processing instruction based on the failure processing parameter.

In 240, sending the failure processing instruction via the device sensor network platform to a maintenance personnel terminal of the device perception and control platform or to a failure shooting device, and controlling the failure shooting device to perform failure shooting.

The maintenance personnel terminal is a device that interacts with the device perception and control platform 150. The maintenance personnel terminal may be configured as at least one of a personal computer, a mobile phone, a tablet computer, etc.

In some embodiments, the device management platform 130 may, in response to determining that a maintenance parameter exists in the failure processing parameter, send the failure processing instruction, via the sensor network platform, to the maintenance personnel terminal of corresponding maintenance personnel of the device perception and control platform 150. The maintenance personnel may troubleshoot the abnormal device on receiving the failure processing instruction. More descriptions of the maintenance parameter may be found in the related descriptions above.

The failure shooting device refers to various types of hardware or software tools used to detect, diagnose, and repair device failures. In some embodiments, the failure shooting device may be at least one of a robotic arm, a robot, etc.

In some embodiments, the device management platform 130 may, in response to determining that a failure shooting parameter exists in the failure processing parameter, send the failure processing instruction to the corresponding failure shooting device via the sensor network platform. The failure shooting device may perform failure shooting on the abnormal device based on the failure processing instruction. More descriptions of the failure processing parameter may be found in the related descriptions above.

In some embodiments of the present disclosure, not only the real-time operation data of the device is considered, but also the historical operation log data, the historical failure data, and the peripheral associated data of the device are takin in account for a comprehensive analysis, so as to more accurately diagnose the device failure of the abnormal device. Based on the confidence level of the failure and the failure processing parameter, clearer guidance is provided for the failure processing, and the efficiency and effectiveness of the failure processing are improved.

In some embodiments of the present disclosure, the occurrence of device failures is reduced, and the stability and productivity of the production line are improved through real-time monitoring and preventive maintenance. Through timely diagnosis and processing of device failures, the impact of device failures on production can be reduced, and the reliability and service life of the device can be improved.

It should be noted that the foregoing descriptions of the process 200 is intended to be exemplary and illustrative only and does not limit the scope of the present disclosure. For those skilled in the art, various modifications and changes may be made to the process 200 under the guidance of the present disclosure. However, these modifications and changes remain within the scope of the present disclosure.

FIG. 3 is a flowchart of an exemplary process for predicting failure warning information and a confidence level according to some embodiments of the present disclosure. Process 300 is a process for predicting the failure warning information and the confidence level of the abnormal device. In some embodiments, process 300 may include operations 310-340, as shown in FIG. 3. Operations 310-340 may be performed by the device management platform 130 of the system 100 for intelligent diagnosis of the device failure based on the IIoT.

In 310, determining target log data and a similar confidence level of the target log data based on real-time log data and historical log data of a preset period.

More descriptions of the real-time log data and the historical log data may be found in FIG. 2 and the related descriptions.

The preset period is a period of time set up in advance. In some embodiments, the preset period may be set based on experience or demand.

In some embodiments, a duration of the preset period is related to a time concentration of the failures of the abnormal device.

The time concentration is used to measure a temporal concentration of failures that have occurred on a particular abnormal device, relative to a temporal concentration of failures that have occurred on all abnormal devices.

In some embodiments, the time concentration may be determined based on historical failure data of an abnormal device and historical failure data of all abnormal devices. For example, the device management platform 130 may determine an average interval time between all adjacent failure times in the historical failure data of the abnormal device and take the average interval time as a first failure time, determine an average interval time between all adjacent failure times in the historical failure data of all abnormal devices and take the average interval time as a second failure time, and determine the time concentration based on the first failure time and the second failure time.

The abnormal device is an abnormal device identified at the current moment. All abnormal devices refer to all devices that are determined as abnormal at all historical moments and at the current moment. The first failure time reflects a duration of the interval time between failures of the abnormal device. The second failure time reflects a duration of the interval time between failures of all the abnormal devices. The time concentration is negatively correlated with the first failure time and positively correlated with the second failure time. In some embodiments, the device management platform 130 may determine a ratio of the second failure time to the first failure time as the time concentration.

In some embodiments, the duration of the preset period may be negatively correlated with the time concentration of the failures of the abnormal device. The device management platform 130 may determine the duration of the preset period based on the time concentration by formula (1), which is shown below:

$$duration of the preset period = base time duration \div ( p \times time concentration ) , \qquad ( 1 )$$

wherein p indicates a coefficient greater than 0, and p may be set empirically.

The base time duration is a reference duration for calculating the duration of the preset period, and the base time duration may be set empirically, such as taking an average interval time between all the failures as the base time duration. For the abnormal device with a low time concentration, where the failures occur at more dispersed times, a longer preset period is selected to ensure that the historical log data of the preset period includes the historical log data corresponding to the times when the abnormal device fails.

By determining the duration of the preset time period based on the failure time concentration, the selected historical data can be tailored to a relative feature of the failures of the device, which allows the duration of the preset period to be selected according to the relative feature of the failures of the device, thereby making the historical log data of the chosen preset period more aligned with the situation of the abnormal device.

In some embodiments, the duration of the preset period is related to a data analyzability.

The data analyzability is used to measure how difficult it is to analyze data. The lower the data analyzability is, the more difficult it is to analyze the data. For example, if data to be analyzed requires a relatively long period of observation, it is difficult to analyze the data, and the data analyzability is low. The data to be analyzed is data in the historical log data to be determined abnormal or not, e.g., operation data of the abnormal device. More descriptions of the operation data may be found in FIG. 2 and the related descriptions thereof.

In some embodiments, the device management platform 130 may determine the data analyzability based on a fluctuation in the data to be analyzed over a first preset period. The greater the fluctuation is, the greater an ability of observing changes in the data to be analyzed is, and the greater the data analyzability is. The fluctuation is related to a statistic value of the data to be analyzed, which may include a standard deviation and a mean value. The first preset period is a relatively long period of time set in advance, for example, one year.

In some embodiments, the device management platform 130 may determine a ratio of the standard deviation to the mean value of the data to be analyzed over the first preset period as the data analyzability.

In some embodiments, the device management platform 130 may determine the duration of the preset period based on the data analyzability and the time concentration. The duration of the preset period is negatively correlated with the data analyzability and the time concentration. For example, the device management platform 130 may determine the duration of the preset period by formula (2), which is shown below:

$$duration of the preset period = duration of base time \div ( p \times time concentration + q \times data analyzability ) , \qquad ( 2 )$$

wherein q indicates a coefficient greater than 0, and q may be set empirically. Descriptions of the duration of the base time, the time concentration, and the coefficient p may be found in the relevant description of formula (1) above.

By considering the data analyzability, the duration of the preset period can be determined based on the feature of the data of the historical log data, thereby making the historical log data of the selected preset period more reasonable, facilitating subsequent analysis.

The target log data is target data that is expected to be retrieved from the historical log data.

In some embodiments, the device management platform 130 may construct a first feature vector based on real-time operation data, real-time statistic data, real-time alarm data, a device real-time location, real-time status data, etc., in the real-time log data, construct a plurality of first reference vectors based on historical operation data, historical statistic data, historical alarm data, a device historical location, historical status data etc., of a plurality of historical moments in the historical log data of the preset period, determine a similarity between the first feature vector and each of the plurality of the first reference vectors, and determine the historical log data corresponding to the first reference vector having a highest similarity with the first feature vector as the target log data. The similarity may be expressed as the reciprocal of a vector distance, which may be a cosine distance, a Euclidean distance, etc.

The similar confidence level of the target log data is a confidence level that the target log data is similar to the real-time log data. In some embodiments, the device management platform 130 may determine a similarity between the target log data and the real-time log data as the similar confidence level of the target log data.

In 320, obtaining historical failure data of a second timestamp based on a first timestamp where the target log data is located. More descriptions of the historical failure data may be found in FIG. 2.

The first timestamp is a time point in which the target log data is located. The second timestamp is a next timestamp adjacent to the first timestamp. In some embodiments, the device management platform 130 may determine, based on the first timestamp of the target log data, the next timestamp of the time point of the target log data in the historical log data as the second timestamp, and obtain historical failure data of the second timestamp uploaded by the device perception and control platform 150 based on the device sensor network platform 140.

In 330, determining a failure key feature based on real-time log data, peripheral associated data, and the historical failure data of the second timestamp. More descriptions of the real-time log data and the peripheral associated data may be found in FIG. 2.

The failure key feature is a data feature that is most likely to cause a failure of the abnormal device. For example, if the failure of the abnormal device is most likely to be a result of a high voltage, the failure key feature is a feature related to the voltage.

In some embodiments, for a piece of real-time log data, the device management platform 130 may construct a sample database based on historical data corresponding to the piece of real-time log data, construct a frequent item database based on data in the sample database, and construct a second feature vector to query the frequent item database, based on the real-time log data, the peripheral associated data, and the historical failure data of the second timestamp. The device management platform 130 may construct a plurality of second reference vectors based on frequent items, and determine the frequent item corresponding to the second reference vector whose similarity with the second feature vector is greater than a similarity threshold and has a highest support degree as the failure key feature of the device. The similarity is negatively correlated with a vector distance between the second feature vector and the second reference vector, which may be a cosine distance.

The sample database is a database that provides sample data for the frequent item database. In some embodiments, the device management platform 130 may obtain the historical failure data of all devices of a same type as the abnormal device. For each piece of historical failure data of each device, the device management platform 130 may obtain, based on a timestamp of the piece of historical failure data, the historical log data and the peripheral associated data of the device in the timestamp, determine the historical log data, the peripheral associated data, and the piece of historical failure data of the device as a set of sample data, and store the set of sample data in the sample database. In this manner, the device management platform 130 may obtain a plurality of sets of sample data, and store the plurality of sets of sample data in the sample database. The historical log data includes a plurality of feature items, such as a current, a voltage, a running duration, etc. The historical failure data includes a plurality of feature items such as a failure time and a failure type. Therefore, each set of sample data in the sample database includes a plurality of feature items. In some embodiments, the feature items included in different sets of sample data may be the same or different, as the device may have failures at different moments. Exemplarily, a set of sample data may be DEG or ABCDEFG, wherein A, B, C, D, E, F, and G are different feature items.

The frequent item database is a database that records data with a high count of failures. The frequent item database includes frequent items and their corresponding support degrees. A frequent item is a set of data that satisfy the need to appear frequently in the sample database. In some embodiments of the present disclosure, the device management platform 130 may construct the frequent item database by the following operations: (1) randomly selecting a set of sample data in the sample database as the target data, determining a plurality of sets of matching data of the target data in the sample database based on a character matching algorithm, and determining the support degree of the target data based on the plurality of sets of matching data; (2) repeating operation (1) until the support degree corresponding to each set of sample data in the database is determined; (3) determining the set of sample data whose support degree is greater than a support degree threshold as a frequent item; and (4) constructing the frequent item database based on the frequent items and the support degrees.

The character matching algorithm may be a brute force (BF) matching algorithm, a Knuth-Morris-Pratt (KMP) algorithm, or other character matching algorithms, which are not limited in the present disclosure.

The set matching data is a set of sample data in the sample database that may match the target data. For example, if the target data is DEF, sample data 1 is ABCDEFG, and sample data 2 is BCEFG, the “DEF” segment in the sample data 1 is consistent with the target data, then sample data 1 may be determined as the set of matching data for the target data, and sample data 2 is regarded as not matching with the target data.

The support degree is used to reflect how well the target data matches the matching data in the sample database. In some embodiments of the present disclosure, the device management platform 130 may determine a count of the sets of matching data in the sample database that match the target data as the support degree of the target data.

The support degree threshold is a critical value of the support degree. In some embodiments of the present disclosure, the support degree threshold may be preset based on experience.

In some embodiments of the present disclosure, the device management platform 130 may include all pieces of sample data whose support degrees are greater than the support degree threshold and their corresponding support degrees in the frequent item database.

The similarity threshold is a critical value of the similarity between the second reference vector and the second feature vector. The second reference vector may be aligned by complementary zeros if the second reference vector and the second eigenvector have different vector lengths. In some embodiments of the present disclosure, the similarity threshold may be preset empirically, e.g., set to 0.8%. In some embodiments of the present disclosure, the similarity threshold is correlated with a computational power of the device management platform 130 and an allowable error. The computational power of the device management platform 130 may be expressed as an average query time of the device management platform 130. The average query time is an average time used by the device management platform 130 to query the frequent item database. The allowable error is an error that is allowed to exist in the similarity threshold. The allowable error is positively correlated with the confidence level corresponding to the failure key feature. In some embodiments of the present disclosure, the similarity threshold is positively correlated with the computational power and the allowable error. For example, the device management platform 130 may obtain the similarity threshold by formula (3), which is shown below:

$$similarity threshold = {w}_{1} \times computational power + {w}_{2} \times allowable error , \qquad ( 3 )$$

wherein w₁ and w₂ indicate constants greater than 0, which may be preset based on experience or demand.

In some embodiments of the present disclosure, the support degree threshold is related to a failure concentration of the abnormal device, the failure concentration is related to a failure distribution, and the failure distribution is determined based on the historical failure data of all abnormal devices.

The failure distribution is a distribution of failures in the historical failure data. The failure distribution includes all types of failures of devices of a same type as the abnormal device and the corresponding count of failures of the devices. The failure distribution may be determined by counting the historical failure data of all devices.

The failure concentration refers to a degree to which failures are concentrated on the abnormal device. In some embodiments of the present disclosure, for each type of failures of the abnormal device, the device management platform 130 may determine a percentage of a count of the type of failures of the abnormal device to a total count of all types of failures in the failure distribution, and determine a statistic value of the percentage as the failure concentration of the abnormal device. The statistic value may be an average value, etc.

In some embodiments of the present disclosure, the support degree threshold is positively correlated to the failure concentration.

Considering the failure distribution of all devices in the whole system 100, if the failure concentration is high, which represents frequent failures of the abnormal device, indicating that the abnormal device is problematic, then appropriately increasing the support degree threshold may better highlight factors affecting failures for the corresponding frequent items. If the failure concentration is low, it indicates that failures may also occur in other devices besides the abnormal device, suggesting potential system-wide issues, in which case lowering the support degree threshold may help better identify other factors contributing to the failures.

In 340, predicting the failure warning information and the confidence level by a device failure model based on the failure key feature and the similar confidence level.

More descriptions of the failure key feature and the similar confidence level may be found in the previous related descriptions. More descriptions of the failure warning information and the confidence level may be found in the relevant description in FIG. 2.

The device failure model is a model used to predict the failure warning information of the abnormal device and the confidence level corresponding to the failure warning information. In some embodiments, the device failure model is a machine learning model. For example, the device failure model may be at least one of a convolutional neural network (CNN) model, a deep neural network (DNN) model, or the like.

In some embodiments, the device failure model may be obtained by training a large count of first training samples and first labels corresponding to the first training samples. In some embodiments, a plurality of first training samples with the first labels may be input into an initial device failure model, a loss function may be constructed from the first labels and results of the initial device failure model, and parameters of the initial device failure model may be iteratively updated based on the loss function via gradient descent or other techniques. The model training is completed when a preset training condition is satisfied, and a trained device failure model is obtained. The preset training condition may include that the loss function converges, a count of iterations reaches a threshold, etc.

Each set of training samples of the plurality of first training samples may include a historical failure key feature and a historical similar confidence level for a historical time point in historical data. The first labels are sample failure warning information and sample confidence levels corresponding to the sets of first training samples. In some embodiments of the present disclosure, a set of first training samples corresponds to a historical failure key feature and a historical similar confidence level for a historical time point, an alarm message after the historical time point in the historical data may be determined as the sample failure warning information in the first label, and the sample confidence level thereof is determined based on the sample failure warning information and subsequent actual failure information. For example, if there is an alarm message after the historical time point in the historical data, a subsequent failure occurs, and the failure is consistent with the alarm message, then the confidence level in the first label is labeled as a high level. As another example, if there is an alarm message after the historical time point and a subsequent failure occurs, but the failure is inconsistent with the alarm message, then the confidence level in the first label is labeled as a medium level. As yet another example, if there is an alarm message after the historical time point and a subsequent failure does not occur, the confidence level in the first label is labeled as a low level.

The beneficial effects of some embodiments of the present disclosure include at least the following. (1) By adopting a similarity matching manner to determine the historical record that is most similar to the current situation by comparing the real-time log data and the historical log data, and selecting the historical log data that has a high degree of similarity to the real-time log data can more accurately predict potential failures and issue early warnings to improve the accuracy of failure prediction. (2) By searching for the historical failure data at time points adjacent to the corresponding timestamps of the target log data, the system is able to more quickly locate the possible types of failures, the time of occurrence of the failures, and the causes of the failures, so as to provide timely and targeted failure warnings. (3) Extracting the failure key feature from a plurality of data sources can reflect more comprehensively the operational status and potential failure risks of the device. Based on the failure key feature, the device failure model can more accurately predict the failure warning information and improve the reliability and effectiveness of predictions. (4) The device failure model is trained based on a large amount of historical log data, realizing data-driven intelligent maintenance, which not only improves the efficiency and accuracy of maintenance, but also reduces the maintenance cost and improves the availability and reliability of the device.

FIG. 4 is a flowchart of an exemplary process for determining a device failure type and a failure processing parameter according to some embodiments of the present disclosure.

In some embodiments, as shown in FIG. 4, the device management platform 130 may be configured to: in response to a confidence level meeting a preset condition, construct a failure knowledge map 420 based on device-related data 410 and store the failure knowledge map 420 in the management data center 131, and determine, based on the failure knowledge map 420, a device failure type 441 and a failure processing parameter 442 by a failure diagnosis model 430. More descriptions of the device-related data, the device failure type, and the failure processing parameter may be found in FIG. 2 and the related descriptions thereof.

The device failure type is a failure type of the abnormal device that may occur in the future, e.g., aging and deformation of the device, software failure, missing parts, incorrect identification of parts, etc.

The preset condition may be the confidence level being greater than a preset level, e.g., the confidence level being greater than a low level, i.e., the confidence level is a medium level or a high level. The preset condition maybe set artificially based on experience or demand.

In some embodiments, the device management platform 130 may construct the failure knowledge map by a preset technique based on the device-related data, failure warning information, a historical failure processing parameter, etc. More descriptions of the failure warning information may be found in FIG. 2 and the related descriptions thereof.

The historical failure processing parameter includes historical device maintenance steps, historical tools or parts required for maintenance, historical estimated maintenance time, historical maintenance personnel, etc.

The preset technique is a technique for processing data, e.g., NLP (Natural Language Processing) techniques, etc. Exemplarily, the device management platform 130 may form a network structure by extracting relationships, attributes, etc., between entities through the NLP technology based on the device-related data, the failure warning information, and the historical failure processing parameter, and determine the network structure as the failure knowledge map.

The failure knowledge map is a structured semantic knowledge base that reflects relationships between entities at the time of a failure.

The entities are things that are distinguishable and exist independently. In some embodiments, the entities may include different types of parameter items in the device-related data, the failure warning information, and the historical failure processing parameter, such as, historical failure data, types of warned failures, the historical maintenance steps, etc.

In some embodiments, the failure knowledge map includes entities and edges. The edges indicate relationships between the entities, and attributes of the edges include an inclusion relationship, an influencing relationship, etc. For example, the relationship between the historical failure data, a failure part, and the failure data is the inclusion relationship. As another example, the relationship between the historical failure data and a device affected by the historical failure data is the influence relationship.

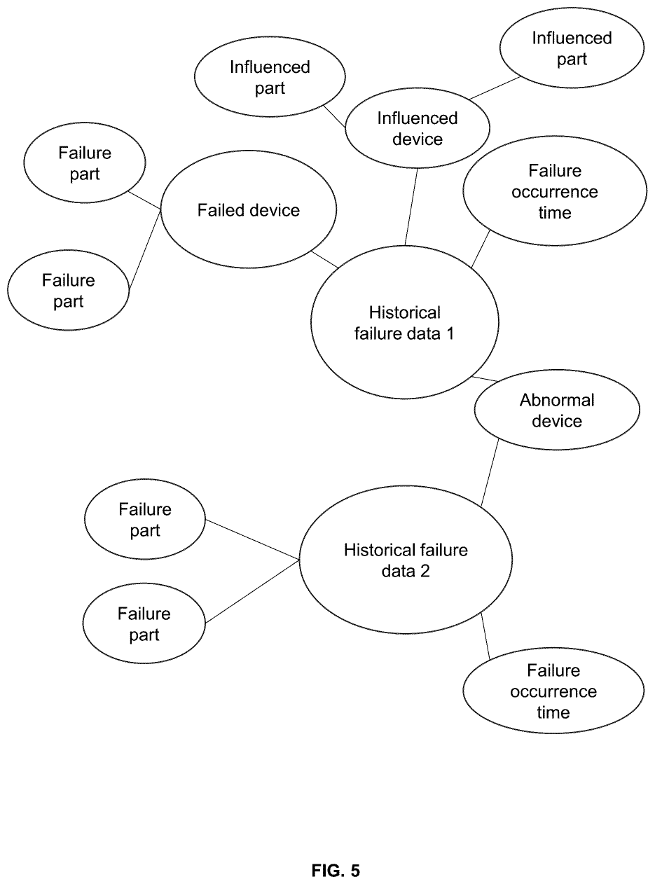

FIG. 5 is an exemplary partial schematic diagram of a failure knowledge map according to some embodiments of the present disclosure. Exemplarily, as shown in FIG. 5, entities in the failure knowledge map include an abnormal device, historical failure data of the abnormal device, a failed device, one or more failure parts, an influenced device, one or more influenced parts, one or more failure occurrence times, etc. Historical failure data 1 corresponds to an abnormal device that is not the same with the failed device; and historical failure data 2 corresponds to an abnormal device that is the same with the failed device.

A failure part is a part that caused the failure to occur. The failure part may be a part involved at the time of the failure, or before the occurrence of the failure, or there may be no failure parts in the failure data.

An influenced part is a part that is affected by the failure after the occurrence of the failure, such as a part with subsequent assembly abnormalities.

In some embodiments, the device management platform 130 may update the failure knowledge map periodically.

An updating period of the failure knowledge map may be preset according to requirements. For example, the updating period may be set to a period in which the device perception and control platform 150 acquires data.

In some embodiments, the device association platform 130 may periodically update the failure knowledge map based on real-time log data obtained by the device perception and control platform 150.

The failure diagnosis model 430 is a model for determining the failure type and the failure processing parameter. In some embodiments, the failure diagnosis model is a machine learning model. For example, the failure diagnosis model may be at least one of a Recurrent Neural Network (RNN) model, a Graph Neural Network (GNN) model, or the like.

In some embodiments, the failure diagnosis model may be obtained by training a large count of second training samples and second labels corresponding to the second training samples. The specific training process is similar to the training process of the device failure model, which may be found in FIG. 3 and the related descriptions.

Each set of training samples of the second training samples may include a historical failure knowledge map constructed based on historical data. The second labels are the device failure types and the failure processing parameters corresponding to the second training samples. In some embodiments, subsequent actually detected device failure types and the historical failure processing parameters for which a processing effect satisfies a preset processing condition may be determined as the second labels. The processing effect satisfying the preset processing condition may include that a same failure does not reoccur in a subsequent preset period after the failure processing.

The beneficial effects of some embodiments of the present disclosure may include at least the following. (1) By constructing the failure knowledge map, it is possible to quickly retrieve information, such as the historical failure processing parameter, related to the current failure type, which reduces the time for failure shooting and maintenance, improves the efficiency of the maintenance personnel in handling the failures, and reduces the maintenance cost. (2) The NLP technology is utilized, which can automatically identify data labels related to device failures from text data, and extract a relationship between each data label to establish a mapping through a preset rule, thus making the construction of the knowledge graph more efficient and accurate, and providing a strong support for the subsequent failure processing. (3) Training the failure diagnosis model through a large amount of data, based on which the failure diagnosis model can more accurately identify the failure type, output the failure processing parameter, and provide more professional guidance for the maintenance personnel. (4) Through timely and accurate failure warning and failure shooting, the system is able to minimize the impact of device failures on production operations and reduce downtime and production losses due to failures.

In some embodiments, the device management platform 130 may be configured to: in response to determining that the failure knowledge map includes part information associated with the abnormal device, determine whether a first associated part exists based on the failure warning information and detection information of at least one assembled product, and in response to determining that the first associated part exists, determine the device failure type and the failure processing parameter based on the first associated part.

The part information associated with the abnormal device is information of the part associated with the abnormal device.

The assembled product is a product produced by an assembly device that performs assembly of parts on a production line. The device that performs assembly of parts includes a plurality of abnormal devices and/or other normal devices. The other normal devices may be devices whose device-related data satisfies a preset abnormal condition. More descriptions of the preset abnormal condition may be found in FIG. 2 and the related descriptions thereof.

The detection information of the assembled product is information obtained by testing the assembled product. For example, the detection information may include whether the assembled product passes a test. The detection information may be expressed as a Boolean value, for example, 0 means that the assembled product fails the test and 1 means that the assembled product passes the test. In some embodiments, the device management platform 130 may obtain, via the service platform 120, the detection information of the assembled product uploaded by an inspector via a user terminal on the user platform 110.

The first associated part is a part that causes a failure to occur in the assembly device.

In some embodiments, in response to determining that the failure knowledge map includes the part information associated with the abnormal device, and the part information includes the failure part, the device management platform 130 may determine the failure part as the first associated part. If the failure part is not included in the part information, the first associated part is determined by looking up a second preset relationship table based on the failure warning information and the detection information of the at least one assembled product. The second preset relationship table includes a mapping relationship of the first associated part with the failure warning information and the detection information of the at least one assembled product. The mapping relationship may be set based on historical data or experience. In some embodiments, the device management platform 130 may count the parts in the historical data that are subsequently actually impacted under the alarm message and include the parts in the second preset relationship table.

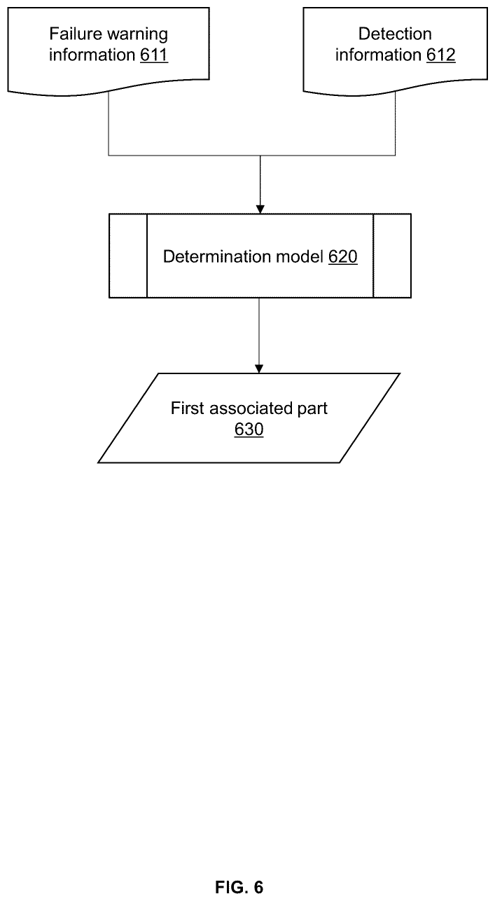

In some embodiments, the device management platform 130 may determine the first associated part based on the failure warning information and the detection information by a determination model. More descriptions of the determination model may be found in FIG. 6.

In some embodiments, in response to determining that the first associated part exists, the device management platform 130 may determine the device failure type of the device corresponding to the first associated part as a part identification error, and set the failure processing parameter to exclude the first associated part.

The failure may occur because of the failure part (e.g., issues with appearance dimensions of the failure part) that causes the assembly device to malfunction by not being able to assemble or identify parts when performing assembly of the parts. The failure may include a mechanical failure and an electronic failure. The failure may also occur when the assembly device is assembling the parts. For example, if an order of transfer of the parts changes, the assembly device may not identify the parts correctly. In a mixed production line, where processes are continuous and uninterrupted, if such failures are not promptly identified, their impact may expand. Identifying the first associated part can effectively prevent the spread of failures.

In some embodiments, the failure processing parameter further includes an adjustment transmission parameter.

The adjustment transmission parameter is an adjusted transmission parameter. The transmission parameter is a parameter that reflects transmission of the parts on the mixed production line. For example, the transmission parameter may include a transmission speed, a transmission time, etc.

In some embodiments, the device management platform 130 may determine a second associated part based on the failure knowledge map, determine the adjustment transmission parameter based on the second associated part, and adjust a transmission parameter to the adjustment transmission parameter

The second associated part is a part affected by the failure of the abnormal device.

In some embodiments, the device management platform 130 may determine a first entity based on the failure knowledge map, and determine a second entity based on the first entity. The device management platform 130 may identify the part represented by the second entity as the second associated part. The first entity is an entity directly associated with the failure that occurs, for example, an abnormal device that has failed, failure data, etc. The second entity is an entity that is associated with the first entity and whose entity type is a part.

In some embodiments, the device management platform 130 may categorize second associated parts according to different production lines, determine a percentage of the second associated parts on each production line, and determine the adjustment transmission parameter based on the percentage. The adjustment transmission parameter includes an adjustment transmission speed. The adjustment transmission speed is an adjusted transmission speed. The adjustment transmission speed is negatively correlated with the percentage of the second associated part in the production line. For example, the device management platform 130 may determine the adjustment transmission speed based on formula (4), which is shown below:

adjustment transmission speed=(1−a)×current transmission speed of the production line, (4)

wherein a indicates the percentage of the second associated part in the production line.

By adjusting the transmission speed of the production line, it is possible to reduce the subsequent impact of failures, buying time for failure shooting without having to stop production to troubleshoot, and also reducing the impact on production.

FIG. 6 is an exemplary schematic diagram of a determination model according to some embodiments of the present disclosure.

In some embodiments, as shown in FIG. 6, the device management platform 130 may determine a first associated part 630 based on failure warning information 611 and detection information 612 by a determination model 620. More descriptions of the failure warning information may be found in FIG. 2 and the related descriptions thereof. More descriptions of the detection information and the first associated part may be found in FIG. 4 and the related descriptions thereof.

The determination model 620 is a model for determining the first associated part. In some embodiments, the determination model is a machine learning model. For example, the determination model may be at least one of a Neural Networks (NN) model, a CNN model, or the like.

In some embodiments, the determination model may be obtained by training a large count of third training samples and third labels corresponding to the third training samples. The specific training process of the determination model is similar to the training process of the device failure model, which may be found in FIG. 3 and the related descriptions thereof.

Each set of training samples of the third training samples may include historical failure warning information and historical detection information of at least one assembled product in historical data. The third labels are sample first associated parts corresponding to the third training samples. In some embodiments, during subsequent actual failure shooting, parts related to failures of the corresponding third training samples may be determined as the third labels.

In some embodiments, the determination model may be obtained through at least a first stage of training, and the first stage of training includes: training based on a first training set, verifying based on a first verification set, and testing based on a first test set.

The first training set is a sample dataset used for training an internal parameter of the determination model. The first verification set is a sample dataset used to verify a state of the determination model. The first test set is a sample dataset used to test a generalization ability of the determination model.

In some embodiments, the first training set, the first test set, and the first verification set are determined based on the historical failure warning information and the historical detection information of the at least one assembled product in the historical data. A first data amount of the first training set, a second data amount of the first test set, and a third data amount of the first verification set are in a preset proportion. The preset proportion may be set based on experience. Exemplarily, the preset proportion may be 8:1:1, etc.

In some embodiments, there is no data overlap between the first training set, the first test set, and the first verification set. In other words, a same piece of data only exists in one of the first training set, the first test set, or the first verification set.

In some embodiments, a sample statistical difference of the first training set is greater than a preset difference threshold.

The sample statistic difference is used to reflect sample diversity of the first training set. The larger the sample statistic difference is, the larger the sample diversity is.

In some embodiments, the device management platform 130 may determine the sample statistical difference based on a preset algorithm. The preset algorithm is a computational operation for determining the sample statistic difference and may be preset in advance.

For example, the device management platform 130 may quantify the historical failure warning information of each sample and the historical detection information of the at least one assembled product in the first training set into numbers, construct numeric vectors based on the samples that have been quantified into numbers, and determine vector distances between pairs of samples in the first training set. The vector distance may be a cosine distance, and a statistic value of a plurality of vector distances may be determined, the larger the statistic value is, the larger the statistical difference of the samples is.

The preset difference threshold is a critical value for the statistical difference of the samples. In some embodiments, the preset difference threshold is related to a statistic value of a count of historical first associated parts. The statistic value of the count of the historical first associated parts may be a variance of the count of the historical first associated parts. For example, the larger the variance of the count of the first associated parts is, the greater the preset difference threshold is.

Training, verifying, and testing the determination model with different proportions of sample data can improve the accuracy and stability of the determination model. Introducing the statistical difference of the samples can make the determination model more robust and prevent the model from overfitting. A larger variance of the count of the first associated parts indicates a higher level of uncertainty and potential impact of the first associated parts. Therefore, the preset difference threshold may be adjusted upward to allow the determination model to learn from a broader distribution of data samples, thereby outputting more accurate predictions.

Determining the first associated part by the determination model allows for automated and rapid determination of the first associated part, thereby further improving the processing efficiency of the system for intelligent diagnosis of the device failure based on the IIoT. In addition, the determination model is obtained based on the training of a large amount of sample data, which can make the predicted first associated parts more accurate.

In some embodiments of the present disclosure, a computer-readable storage medium is provided. The storage medium may store one or more sets of computer instructions, and when a computer reads the one or more sets of computer instructions in the storage medium, the computer implements the method for intelligent diagnosis of the device failure based on the IIoT described in any one of the embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

It should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the count of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for intelligent diagnosis of a device failure based on an Industrial Internet of Things (IIoT), the method being executed by a device management platform of a system for intelligent diagnosis of a device failure based on an IIoT, and the method comprising:
obtaining device-related data of an abnormal device from a total sensor database, wherein the device-related data includes at least one of real-time log data, historical log data, historical failure data, and peripheral associated data, and the device-related data is obtained from a device perception and control platform through a device sensor network platform;
predicting failure warning information of the abnormal device and a confidence level corresponding to the failure warning information based on the device-related data;
determining a failure processing parameter based on the failure warning information and the confidence level, and generating a failure processing instruction; and
sending the failure processing instruction via the device sensor network platform to a maintenance personnel terminal of the device perception and control platform or to a failure shooting device, and controlling the failure shooting device to perform failure shooting.

2. The method of claim 1, wherein the predicting failure warning information of the abnormal device and a confidence level corresponding to the failure warning information based on the device-related data includes:
determining target log data and a similar confidence level of the target log data based on the real-time log data and historical log data of a preset period;
obtaining historical failure data of a second timestamp based on a first timestamp where the target log data is located, wherein the second timestamp is a next timestamp adjacent to the first timestamp;
determining a failure key feature based on the real-time log data, the peripheral associated data, and the historical failure data of the second timestamp; and
predicting the failure warning information and the confidence level by a device failure model based on the failure key feature and the similar confidence level, wherein the device failure model is a machine learning model.

3. The method of claim 2, wherein a duration of the preset period is related to a time concentration of failures of the abnormal device, the time concentration is determined based on historical failure data of the abnormal device and historical failure data of all abnormal devices.

4. The method of claim 3, wherein the duration of the preset period is related to a data analyzability.

5. The method of claim 1, wherein the determining a failure processing parameter based on the failure warning information and the confidence level, and generating a failure processing instruction includes:
in response to the confidence level meeting a preset condition, constructing a failure knowledge map based on the device-related data and storing the failure knowledge map in a management data center; and
determining, based on the failure knowledge map, a device failure type and the failure processing parameter by a failure diagnosis model, wherein the failure diagnosis model is a machine learning model.

6. The method of claim 5, wherein the method further comprises:
updating the failure knowledge map periodically.

7. The method of claim 5, further comprising:
in response to determining that the failure knowledge map includes part information associated with the abnormal device, determining whether a first associated part exists based on the failure warning information and detection information of at least one assembled product, wherein the first associated part is a part that causes an assembled device abnormal; and
in response to determining that the first associated part exists, determining the device failure type and the failure processing parameter based on the first associated part.

8. The method of claim 7, wherein the determining whether a first associated part exists based on the failure warning information and detection information of at least one assembled product includes:
determining the first associated part based on the failure warning information and the detection information by a determination model, wherein the determination model is a machine learning model.

9. The method of claim 8, wherein the determination model is obtained through at least a first stage of training, and the first stage of training includes: training based on a first training set, verifying based on a first verification set, and testing based on a first test set, wherein:
the first training set, the first test set, and the first verification set are determined based on historical failure warning information and historical detection information of the at least one assembled product in historical data, wherein a first data amount of the first training set, a second data amount of the first test set, and a third data amount of the first verification set are in a preset proportion, and there is no data overlap between the first training set, the first test set, and the first verification set; and
a sample statistical difference of the first training set is greater than a preset difference threshold, wherein the preset difference threshold is related to a statistic value of a count of historical first associated parts.

10. The method of claim 5, wherein the failure processing parameter further includes an adjustment transmission parameter, and the method further comprises:
determining a second associated part based on the failure knowledge map, wherein the second associated part is an affected part after the failure of the abnormal device; and
determining the adjustment transmission parameter based on the second associated part and adjusting a transmission parameter to the adjustment transmission parameter.

11. A system for intelligent diagnosis of a device failure based on an Industrial Internet of Things (IIoT), comprising a user platform, a service platform, a device management platform, a device sensor network platform, and a device perception and control platform connected in sequence, wherein
the device management platform includes a management data center and a plurality of device management sub-platforms interacting with the management data center for information exchange, respectively;
the device sensor network platform includes a total sensor database, a plurality of sensor sub-databases, and a plurality of sensor network sub-platforms, the plurality of sensor sub-databases interact with the total sensor database for information exchange, respectively, and the plurality of sensor sub-databases have a one-to-one correspondence with the plurality of sensor network sub-platforms and interact with the plurality of sensor network sub-platforms for information exchange, respectively, and the device sensor network platform interacts with the device management platform for information exchange through the total sensor database;
the device perception and control platform includes a plurality of device perception and control sub-platforms, the device sensor network platform interacts with the plurality of device perception and control sub-platforms of the device perception and control platform for information exchange, respectively, through the plurality of sensor sub-databases; and
the device management platform is configured to:
obtain device-related data of an abnormal device from the total sensor database, wherein the device-related data includes at least one of real-time log data, historical log data, historical failure data, and peripheral associated data, and the device-related data is obtained from the device perception and control platform through the device sensor network platform;
predict failure warning information of the abnormal device and a confidence level corresponding to the failure warning information based on the device-related data;
determine a failure processing parameter based on the failure warning information and the confidence level, and generating a failure processing instruction; and
send the failure processing instruction via the device sensor network platform to a maintenance personnel terminal of the device perception and control platform or to a failure shooting device, and control the failure shooting device to perform failure shooting.

12. The system of claim 11, wherein the device management platform is further configured to:
determine target log data and a similar confidence level of the target log data based on the real-time log data and historical log data of a preset period;
obtain historical failure data of a second timestamp based on a first timestamp where the target log data is located, wherein the second timestamp is a next timestamp adjacent to the first timestamp;
determine a failure key feature based on the real-time log data, the peripheral associated data, and the historical failure data of the second timestamp; and
predict the failure warning information and the confidence level by a device failure model based on the failure key feature and the similar confidence degree, wherein the device failure model is a machine learning model.

13. The system of claim 12, wherein a duration of the preset period is related to a time concentration of failures of the abnormal device, the time concentration is determined based on historical failure data of the abnormal device and the historical failure data of all abnormal devices.

14. The system of claim 13, wherein the duration of the preset period is related to a data analyzability.

15. The system of claim 11, wherein the device management platform is further configured to:
in response to the confidence level meeting a preset condition, construct a failure knowledge map based on the device-related data and store the failure knowledge map in the management data center; and
determine, based on the failure knowledge map, a device failure type and the failure processing parameter by a failure diagnosis model, wherein the failure diagnosis model is a machine learning model.

16. The system of claim 15, wherein the device management platform is further configured to:
in response to determining that the failure knowledge map includes part information associated with the abnormal device, determine whether a first associated part exists based on the failure warning information and detection information of at least one assembled product, wherein the first associated part is a part that causes an assembly device abnormal; and
in response to determining that the first associated part exists, determine the device failure type and the failure processing parameter based on the first associated part.

17. The system of claim 16, wherein the device management platform is further configured to:
determine the first associated part based on the failure warning information and the detection information by a determination model, wherein the determination model is a machine learning model.

18. The system of claim 17, wherein the determination model is obtained through at least a first stage of training, and the first stage of training includes: training based on a first training set, verifying based on a first verification set, and testing based on a first test set, wherein:
the first training set, the first test set, and the first verification set are determined based on historical failure warning information and historical detection information of the at least one assembled product in historical data, wherein a first data amount of the first training set, a second data amount of the first test set, and a third data amount of the first verification set are in a preset proportion, and there is no data overlap between the first training set, the first test set, and the first verification set; and
a sample statistical difference of the first training set is greater than a preset difference threshold, wherein the preset difference threshold is related to a statistic value of a count of historical first associated parts.

19. The system of claim 15, wherein the failure processing parameter further includes an adjustment transmission parameter, and the device management platform is further configured to:
determine a second associated part based on the failure knowledge map, wherein the second associated part is an affected part after the failure of the abnormal device; and
determine the adjustment transmission parameter based on the second associated part and adjust a transmission parameter to the adjustment transmission parameter.

20. A non-transitory computer-readable storage medium, wherein the storage medium stores one or more sets of computer instructions, and when a computer reads the one or more sets of computer instructions in the storage medium, the computer implements the method of claim 1.
